(19) United States
(12) Patent Application Publication
(10) Pub. No.: US 2023/0273364 A1
(43) Pub. Date: Aug. 31, 2023

(54) FLEXIBLE FABRIC FOR AN INTERIOR OF A VEHICLE, SEAT COVER FOR A VEHICLE SEAT, VEHICLE SEAT AND VEHICLE

(71) Applicant: Adient US LLC, Plymouth, MI (US)

(72) Inventor: Thomas DILLINGER, Ratingen (DE)

(21) Appl. No.: 18/007,056

(22) PCT Filed: Jul. 29, 2021
(86) PCT No.: PCT/EP2021/071241

§ 371 Date: Jan. 27, 2023

(30) Foreign Application Priority Data
Jul. 29, 2020 (DE) 10 2020 120 028.5
Nov. 9, 2020 (DE) 10 2020 129 386.0

(51) Int. Cl. F21V 8/00; B60Q 3/62; B60Q 3/233

(52) U.S. Cl. CPC G02B 6/006; B60Q 3/62; B60Q 3/233; B60N 2/58

(57) ABSTRACT

A flexible fabric for an interior of a vehicle, in particular for a vehicle seat, having an opaque top layer, an illuminant and at least one translucent light guide layer which is arranged between the illuminant and the top layer. The top layer has a plurality of cutouts through which light emitted by the illuminant passes, and the plurality of cutouts are filled with protrusions of the at least one light guide layer. Light emitted by the illuminant is guided as far as a surface of a visible side of the flexible fabric before it passes out of the light guide layer, with the result that the protrusions arranged in the cutouts form an illuminated pattern. The flexible fabric may be used with the vehicle seat with a vehicle.

The invention relates to a flexible sheetlike structure for the interior of a vehicle, especially for a vehicle seat, having an essentially opaque outer layer, an illuminant and at least one essentially transparent light guide layer disposed between the illuminant and the outer layer, wherein the outer layer has a multitude of cutouts through which light emitted by the illuminant passes, and the cutouts are filled with elevations in the at least one light guide layer. The invention further relates to a seat cover, to a vehicle seat and to a vehicle.

### PRIOR ART

A flexible sheetlike structure of this kind is known from DE 10 2015 102 407 A1. This known flexible sheetlike structure is a flexible flat luminaire intended especially for use in an item of clothing. In this flat luminaire, the illuminants are arranged spaced apart from a reflection layer by a spacer layer and the light exit side thereof faces this reflection layer. Light emitted by the illuminants is reflected at the reflection layer and is scattered in the spacer layer and further spacer layers on its further path to the outer layer. This is intended to achieve uniform emission of light by the outer layer. After positioning of the illuminants, the spacer layer is arranged above the illuminants and is elastically deformed when the illuminants press into the spacer layer.

A flat luminaire for a vehicle is additionally known from DE 10 2013 021 690 A1. This flat luminaire has layers of polymer material and is thus not a flexible but an essentially rigid sheetlike structure. More particularly, the flat luminaire is thus unsuitable as a cover material.

WO 2018/082810 A1 discloses a flexible sheetlike structure for the interior of a vehicle, a seat cover having the flexible sheetlike structure, a vehicle seat having the seat cover, and a vehicle. In particular, the flexible sheetlike structure is intended for a vehicle seat and has an at least partly transparent outer layer, an illuminant and an at least partly transparent spacer layer disposed at least partly between the illuminants and the outer layer. The spacer layer has at least one embossment line that accommodates the illuminants. This provides large-area backlighting for a flexible sheetlike structure in a vehicle interior.

DE 10 2017 214 943 A1 discloses a lining element on a vehicle exterior, consisting at least of a lining element body and a design region configured for individual adjustment of the external appearance of the vehicle, wherein the design region consists of at least one polymer sheet structured by processing with a laser for a three-dimensional appearance, leaving the outer surface unaffected.

DE 10 2019 104 205 A1 discloses a molded article comprising an opaque decorative layer, having a front side in the form of a viewing side and a reverse side on the opposite side from the front side, wherein a symbol is disposed on the front side of the decorative layer. The decorative layer has one or more light apertures, a transparent or translucent carrier, a light element with at least one light source and one or more light guide inserts. The light guide insert(s) is/are formed from a light-guiding material, with the light guide insert(s) inserted into the light aperture(s). The light guide insert(s) has/have at least one narrow region and at least one broad region, with the narrow region adjoining the broad region and having a length corresponding to the length of the light aperture, and with the broad region having a diameter or width greater than the diameter of the light aperture. The narrow region is inserted into the light aperture, and a side of the broad region facing the decorative layer adjoins the reverse side of the decorative layer.

EP 2 596 991 A1 discloses an illuminable component with a viewing side, an edge surrounding the viewing side and a reverse side, comprising a flat decorative element having at least one transparent region and at least one opaque region, lighting means for illuminating the at least one transparent region, and at least one light-guiding layer disposed between the decorative element and the lighting means, mounted on a reverse side of the decorative element.

### Object

It is an object of the invention to improve a flexible sheetlike structure of the type specified at the outset, especially to provide a sheetlike structure having exactly defined illuminated regions that are visible from a broad viewing angle. In addition, a seat cover having illuminated regions for a vehicle seat, a vehicle seat having such a seat cover, and a vehicle, especially having such a vehicle seat, are to be provided.

### Achievement of Object

The object is achieved in accordance with the invention by a flexible sheetlike structure for an interior of a vehicle, especially for a vehicle seat, having an essentially opaque outer layer, an illuminant and at least one essentially transparent light guide layer disposed between the illuminant and the outer layer, wherein the outer layer has a multitude of cutouts through which light emitted by the illuminant passes, and the cutouts are filled essentially with elevations in the at least one light guide layer, wherein light emitted by the illuminant is directed through to a surface of a viewing side of the flexible sheetlike structure before exiting from the light guide layer, which results in formation of an illuminated pattern in the elevations disposed in the cutouts.

By virtue of light emitted by the illuminant being directed through to a surface of a viewing side of the flexible sheetlike structure before exiting from the light guide layer and forming an illuminated pattern in the elevations disposed in the cutouts, the advantage is achieved that the illuminated pattern formed by the multitude of cutouts is visible from a broader viewing angle compared to the prior art.

What is generally understood by “essentially transparent” in the context of this invention and especially with regard to the light guide layer is that incident light can pass through in a proportion of more than 50%, especially about 80% to 99%. This physical property is also known as transmission.

What is generally understood by “essentially opaque” in the context of this invention and especially with regard to the outer layer is that incident light passes through in a proportion of less than about 5%. This physical property is also known as opacity.

What is meant by cutouts essentially filled with elevations in the at least one light guide layer is that the elevations completely fill the cutouts within the scope of manufacturing tolerance, preferably without protruding relative to a surface of the outer layer.

Moreover, what is meant by “light emitted by the illuminant is directed through to a surface of a viewing side of the flexible sheetlike structure before exiting from the light guide layer” is that the light is passed through the transparent light guide layer up to the surface of the opaque outer layer before exiting from the light guide layer and being emitted directly to an environment, and is explicitly not released into any further layer, especially not into a scatter layer or decorative layer. The surface of the outer layer and a surface of the elevations of the light guide layer form a common face that constitutes the viewing side of the sheetlike structure.

A carrier layer that accommodates the illuminant may be provided on a side of the illuminant remote from the light guide layer.

The cutouts in the outer layer may be created by cutting, especially by a laser. The cutouts in the outer layer may be created by stamping or embossing. The cutouts may be a perforation.

A further light guide layer may be disposed between the light guide layer and the carrier layer. The light guide layers may be formed from an identical material. The light guide layers may be formed from a different material.

The light guide layer may be manufactured from a silicone. The light guide layer may be manufactured from a thermoplastic. The light guide layer may be manufactured from polymethylmethacrylate (PMMA). The light guide layer is preferably transparent. The light guide layer is preferably configured such that a color composition of the light is unaffected.

The light guide layer may be manufactured from a foamed material. The foamed material is preferably color-stable and is manufactured from a non-yellowing foam material.

The further light guide layer may be a textile layer. The further light guide layer preferably has scatter elements at which light passing through the light guide layer is scattered. More preferably, the further light guide layer is a 3D spacer weave or a loop-formed 3D knit or a loop-drawn 3D knit. Filaments of the respective textile layer may be scatter elements in the light guide layer at which light is scattered or else refracted.

The light guide layer may also be configured such that a color composition of the light that passes through the light guide layer can be influenced in accordance with a defined property. Overall, this ensures uniform light distribution in the region of the outer layer and hence a uniform two-dimensional appearance of illuminated regions of the flexible sheetlike structure.

Preferably, the flexible sheetlike structure has a carrier layer, with the light guide layer and the illuminant disposed between the outer layer and the carrier layer. The carrier layer is preferably configured such that incident light is reflected. Light in the light guide layer is thus wholly or partly prevented from exiting from the flexible sheetlike structure on the reverse side, especially a side which is invisible in the installed state, of the flexible sheetlike structure remote from the outer layer. At least some of the light in the light guide layer may be reflected at the carrier layer. The carrier layer is especially a textile layer, more preferably a fabric layer. The carrier layer may be manufactured from a cotton fabric, a mesh fabric or a linen fabric.

The outer layer may be a textile layer. The cutouts in the outer layer may be cut out by a laser.

The illuminant may be a two-dimensionally light-emitting diode. The illuminant may be formed from a multitude of small illuminants. A color composition of the light emitted by the illuminant may be adjustable and/or controllable. The illuminant may emit colored light. The carrier layer, the light guide layer, any further light guide layer and the outer layer may be bonded to one another in mutually adjacent area sections.

A seat cover of the invention for a vehicle seat includes a flexible sheetlike structure of the invention. A vehicle seat of the invention has a seat cover of the invention. A vehicle of the invention has, in its interior, an inner lining including a flexible sheetlike structure of the invention and/or a vehicle seat of the invention.

In summary, and described in other words, it is possible with the above-described flexible sheetlike structure especially to produce an illuminated pattern or an illuminated logo, wherein processing of a high-quality cover material (for example leather) can be maintained, especially without adding a vinyl insert or plastic insert. By perforation of the cover material, it is possible to achieve any design of the pattern or logo. The perforation is preferably filled with a light guide layer. The perforation can thus enable the full optical effect of the illumination even from a lateral viewing angle. A material and a production process for the light guide layer (IM silicone, thermoformed film, direct filling of the holes, etc.) may be set up such that the cover material retains its full flexibility. A hard injection molding made of relatively rigid polymethylmethacrylate (PMMA) is likewise possible, especially in areas where higher value is placed on strength than on comfort.

### FIGURES AND EMBODIMENTS OF THE INVENTION

The invention is elucidated in detail hereinafter by an advantageous working example shown in the figures. However, the invention is not limited to this working example. The figures show:

FIG. 1: a schematic section diagram of a flexible sheetlike structure of the invention,

FIG. 2: a vehicle of the invention including a vehicle seat of the invention and an inner lining of the invention,

FIG. 3: a detail view of a flexible sheetlike structure of the invention in a state with deactivated illuminant,

FIG. 4: a detail view of a flexible sheetlike structure of the invention in a state with activated illuminant, and

FIG. 5: a schematic section diagram of a modification of the flexible sheetlike structure of the invention.

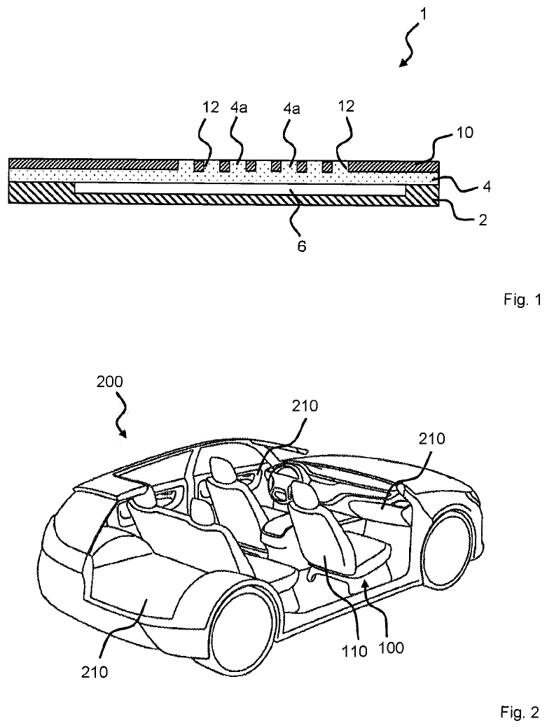

FIG. 1 shows a section diagram of an inventive flexible sheetlike structure 1.

The details of position and direction used, for example front, back, top and bottom, relate to the respective diagrams shown in the figures and are not necessarily restrictive in relation to an installation position of the element described within a vehicle 200. In particular, the sheetlike structure 1 shown in a section diagram in FIG. 1 may be installed in the vehicle 200 in any angular position, especially rotated relative to the diagram of FIG. 1.

The flexible sheetlike structure 1 has a carrier layer 2, a light guide layer 4, an illuminant 6 and an outer layer 10. The flexible sheetlike structure 1 has the light guide layer 4 on the carrier layer 2. The illuminant 6 is disposed on the side of the light guide layer 4 facing the carrier layer 2. The illuminant 6 is preferably a two-dimensionally light-emitting diode. The illuminant 6 is set up to emit light. The carrier layer 2, the illuminant 6 and the light guide layer 4 are preferably bonded to one another.

The outer layer 10 may be a textile layer, a perforated leather layer or a perforated leatherlike layer. The light guide layer 4 is preferably transparent and serves at least partly as a scatter layer in which the light is scattered such that it exits uniformly on a side of the light guide layer 4 remote from the illuminant 6. Individual layers, or all layers, 2, 4, 6 and 10 that join one another two-dimensionally may be bonded to one another, especially adhesive-bonded. For this purpose, it is possible to provide additional layers of adhesive, especially an essentially transparent layer of adhesive, that are not shown for reasons of representation, through which light can penetrate essentially unhindered within the sheetlike structure 1.

The light guide layer 4 is three-dimensional and in the present context has multiple elevations 4a. Each elevation 4a is disposed in a cutout 12 of the outer layer 10. A number of elevations 4a corresponds to a number of cutouts 12. End faces of the elevations 4a are constituents of an outer viewing side of the sheetlike structure 1.

The outer layer 10 has, at least in some regions, the cutouts 12 in which the elevations 4a in the light guide layer 4 are disposed. Light from the illuminant 6 can pass through these elevations 4a, and hence through the cutouts 12. A surface of the outer layer 10 remote from the light guide layer 4 and the end faces of the elevations 4a constitute an outer viewing side of the sheetlike structure 1. No further layer is present above the viewing side of the sheetlike structure 1, especially no scatter layer or decorative layer that connects or covers the multitude of cutouts 12. Every single cutout 12 is identifiable as a single dot in the state with activated illuminant 6 on the viewing side of the sheetlike structure 1, with the multitude of cutouts 12 here forming an illuminated pattern. In regions of the outer layer 10 where there is no cutout 12, the light is essentially reflected and/or absorbed by the underside of the outer layer 10 in the direction of the light guide layer 4.

FIG. 2 shows a vehicle 200 having a vehicle seat 100 and an inner lining 210. The flexible sheetlike structure 1 may be part of a seat cover 110 of the vehicle seat 100, especially of a seat cover 110 in the region of a seat surface, a front side of a backrest or a reverse side of a backrest. The flexible sheetlike structure 1 may be part of the inner lining 210 of the vehicle 200, especially part of a door lining, of a vehicle roof lining or, for example, of a dashboard.

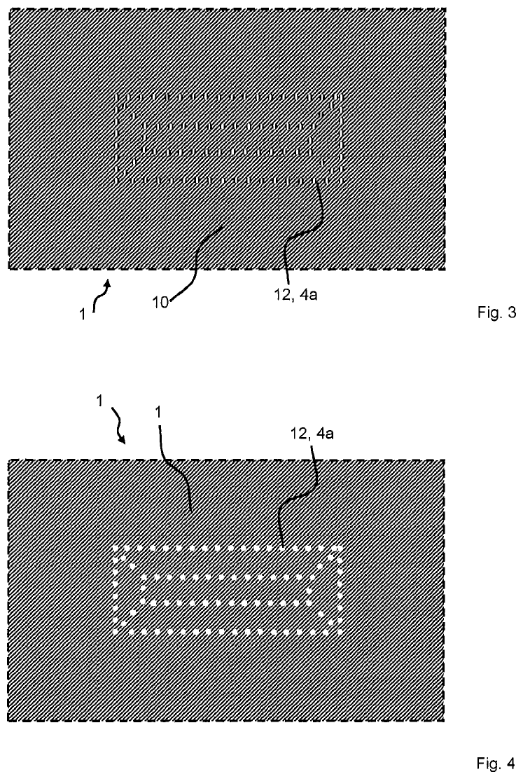

FIGS. 3 and 4 show a detail of the flexible sheetlike structure 1 looking toward the outer layer 10. The illuminant 6 is deactivated in the state shown in FIG. 3 and does not emit any light, with essentially only the outer layer 10 being visible. The cutouts 12 and the elevations 4a are barely visible, if at all, and in particular are not perceptible to an observer.

In FIG. 4, the illuminant 6 is activated and emits light, some of which passes through the cutouts 12. The cutouts 12 and the elevations 4a are more brightly manifested by virtue of the additional illumination by the illuminant 6 and are clearly apparent from an outer surface of the sheetlike structure 1.

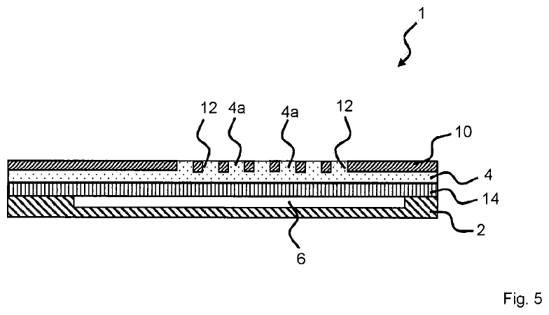

FIG. 5 shows a modification of the flexible sheetlike structure 1 shown in FIG. 1. The modification of the flexible sheetlike structure 1 differs from the working example shown in FIG. 1 merely in that a further light guide layer 14 is disposed between the light guide layer 4 and the carrier layer 2. The further light guide layer 14 has scatter elements at which light passing through the further light guide layer 14 is scattered. This achieves uniform distribution of the light emitted by the illuminant 6. The further light guide layer 14 in the present context is configured as a loop-formed 3D knit.

All the features mentioned in the description above and in the drawing are combinable with one another in any desired selection. The disclosure of the invention is thus not limited to the combinations of features that have been described or claimed or are shown in the drawing; instead, all the combinations of features that are viable within the context of the invention should be considered to be disclosed.

Even though the invention has been described in detail in the drawings and the preceding description, the representations are illustrative and should be considered to be exemplary and nonlimiting. In particular, the choice of proportions of the individual elements as shown in the drawings should not be interpreted as being obligatory or limiting. Furthermore, the invention is especially not limited to the working examples elucidated. Further variants of the invention and the execution thereof will be apparent to the person skilled in the art from the preceding disclosure, figures and claims.

Words used in the claims such as “comprise”, “have”, “include”, “contain” and the like do not rule out further elements or steps. The use of the indefinite article does not rule out a multitude. An individual device may execute the functions of multiple units or devices mentioned in the claims.

### LIST OF REFERENCE NUMERALS

1 flexible sheetlike structure
2 carrier layer
4 light guide layer
4a elevations
6 illuminant
10 outer layer
12 cutout
14 further light guide layer
100 vehicle seat
110 seat cover
200 vehicle
210 inner lining

1-15. (canceled)

16. A flexible sheetlike structure for an interior of a vehicle, comprising: an essentially opaque outer layer, and an illuminant and at least one essentially transparent light guide layer disposed between the illuminant and the outer layer, wherein the outer layer has a multitude of cutouts through which light emitted by the illuminant passes, and the cutouts are filled essentially with elevations in the at least one light guide layer, wherein light emitted by the illuminant is directed through to a surface of a viewing side of the flexible sheetlike structure before exiting from the light guide layer, which results in formation of an illuminated pattern in the elevations disposed in the cutouts.

17. The flexible sheetlike structure as claimed in claim 16, wherein a carrier layer that accommodates the illuminant is provided on a side of the illuminant remote from the light guide layer.

18. The flexible sheetlike structure as claimed in claim 16, wherein the cutouts in the outer layer are created by cutting by a laser, or by stamping or embossing.

19. The flexible sheetlike structure as claimed in claim 16, wherein the light guide layer is manufactured from a silicone or from a thermoplastic.

20. The flexible sheetlike structure as claimed in claim 16, wherein the light guide layer is manufactured from polymethylmethacrylate (PMMA).

21. The flexible sheetlike structure as claimed in claim 16, wherein the light guide layer is transparent.

22. The flexible sheetlike structure as claimed in claim 16, wherein the light guide layer is manufactured from a foamed material.

23. The flexible sheetlike structure as claimed in claim 16, wherein the light guide layer is configured such that a color composition of the light that passes through the light guide layer can be influenced in accordance with a defined property.

24. The flexible sheetlike structure as claimed in claim 16, wherein a further light guide layer is disposed between the light guide layer and a carrier layer.

25. The flexible sheetlike structure as claimed in claim 24, wherein the light guide layer and the further light guide layer are formed from an identical material.

26. The flexible sheetlike structure as claimed in claim 24, wherein the further light guide layer has scatter elements at which light passing through the further light guide layer is scattered.

27. The flexible sheetlike structure as claimed in claim 24, wherein the further light guide layer is a 3D spacer weave or a loop-formed 3D knit or a loop-drawn 3D knit.

28. A seat cover for a vehicle seat including the flexible sheetlike structure as claimed in claim 16.

29. A vehicle seat including the seat cover as claimed in claim 28.

30. A vehicle including an inner lining having the flexible sheetlike structure and/or having the vehicle seat as claimed in claim 29.
